(19) United States
(12) Patent Application Publication
(10) Pub. No.: US 2026/0217487 A1
(43) Pub. Date: Jul. 30, 2026

(54) INSPECTION SYSTEM AND INFORMATION PROCESSING APPARATUS

(71) Applicant: CANON KABUSHIKI KAISHA, Tokyo (JP)

(72) Inventor: MASAAKI MURAISHI, Chiba (JP)

(21) Appl. No.: 19/457,635

(22) Filed: Jan. 23, 2026

(30) Foreign Application Priority Data
Jan. 29, 2025 (JP) 2025-013210

(51) Int. Cl. B65H 7/06; H04N 1/00

(52) U.S. Cl. CPC B65H 7/06; H04N 1/00037

(57) ABSTRACT

An inspection system that compares a scanned image in which a printed matter printed based on a job is scanned with a reference image to inspect the printed matter. The inspection system includes a plurality of discharge destinations, sets an inspection mode and a sheet size to be used for printing of the printed matter for the job, determines whether the plurality of discharge destinations include a discharge destination to which the printed matter having been inspected in the inspection mode is able to be discharged, based on the sheet size and the inspection mode that have been set, and performs control so as to change the inspection mode or the sheet size in a case that it is determined that there is no discharge destination to which the printed matter having been inspected is able to be discharged.

### BACKGROUND

### Field of the Technology

The present disclosure relates to an inspection system and an information processing apparatus.

### Description of the Related Art

Known inspection for confirming whether a printed matter is correctly printed has been performed manually, but in recent years, an inspection system including an inspection apparatus that automatically performs inspection as post-processing of a printing machine is used. In such an inspection system, reference image data is registered, and then the printed matter printed and discharged by an image forming apparatus based on received image data is scanned by a sensor disposed in the inspection apparatus. The inspection apparatus detects an image defect of the printed matter by comparing scanned image data obtained by scanning the printed matter with registered reference image data. Hereinafter, the inspection for detecting a defect of a picture part of the printed matter is referred to as print image inspection.

In this print image inspection, if a printed matter determined not to satisfy a quality criterion and a printed matter determined to satisfy the quality criterion are discharged by the same method, the printed matter not satisfying the quality criterion cannot be discriminated, and sorting work requires time and effort.

In order to solve such a problem, Japanese Patent Laid-Open No. 2023-105790 describes a technique of discharging a printed matter not satisfying the quality criterion and a printed matter satisfying the quality criterion to discharge destinations different from each other.

However, it is necessary for the configuration of Japanese Patent Laid-Open No. 2023-105790 to include a plurality of discharge destinations in order to switch the discharge destinations of the printed matter not satisfying the quality criterion and the printed matter satisfying the quality criterion to discharge them to the discharge destinations different from each other. In addition, depending on the size of the printed matter and the like, discharge destinations to which the printed matter can be discharged may be limited. There is a problem that, even if a plurality of discharge destinations are included, if a plurality of discharge destinations to which a printed matter of a specific size can be discharged do not exist, the discharge destination of the printed matter cannot be designated, and thus inspection of the printed matter cannot be performed..

### SUMMARY

Embodiments of the present disclosure eliminate the above-mentioned issues with conventional technology.

A feature of embodiments of the present disclosure is to provide a technique that is able to avoid a state in which inspection cannot be performed because a discharge destination of the inspected printed matter cannot be designated, by setting an inspection mode in which the printed matter can be discharged, for example, even in the case where a discharge destination to which the printed matter can be discharged is limited.

According to embodiments of the present disclosure, there is provided an inspection system that compares a scanned image in which a printed matter printed based on a job is scanned with a reference image to inspect the printed matter, the inspection system comprising: a plurality of discharge destinations; and one or more controllers including one or more processors and one or more memories, wherein the one or more controllers are configured to: set an inspection mode and a sheet size to be used for printing of the printed matter for the job, determine whether the plurality of discharge destinations include a discharge destination to which the printed matter having been inspected in the inspection mode is able to be discharged, based on the sheet size and the inspection mode that have been set, and perform control so as to change the inspection mode or the sheet size in a case that it is determined that there is no discharge destination to which the printed matter having been inspected is able to be discharged.

Further features of the various embodiments will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 depicts a view for describing a configuration of an inspection system including an inspection apparatus according to a first embodiment of the present disclosure.

FIG. 2 is a block diagram for describing a control configuration of an image forming apparatus, an inspection unit, a large-volume stacker, a finisher, a client, an information processing apparatus, and the inspection apparatus according to the first embodiment.

FIG. 3 depicts a schematic cross-sectional view for describing mechanisms of the image forming apparatus, the inspection unit, the large-volume stacker, and the finisher according to the first embodiment.

FIG. 4 depicts a view illustrating an example of a job property screen to be displayed on a UI unit of the information processing apparatus according to the first embodiment.

FIG. 5 depicts a view illustrating an example of the job property screen to be displayed on the UI unit of the information processing apparatus according to the first embodiment.

FIGS. 6A to 6D depict views describing examples of setting values of each item in the job property screen in an inspection mode according to the first embodiment.

FIG. 7 is a flowchart for describing print setting processing by the information processing apparatus according to the first embodiment.

FIGS. 8A and 8B depict views illustrating examples of a warning screen to be displayed by the information processing apparatus according to the first embodiment.

FIG. 9 is a flowchart for describing inspection processing by the inspection apparatus according to the first embodiment.

FIGS. 10A and 10B are flowcharts for describing job property setting processing by an information processing apparatus according to a second embodiment.

FIG. 11 depicts a view illustrating an example of a table that stores information for determining whether a discharge-enabling condition is met corresponding to discharge destination information according to the second embodiment.

FIGS. 12A to 12C depict views illustrating an example of tables in which discharge destinations to which the printed matter can be discharged or cannot be discharged are registered in association with a sheet size and an inspection mode according to the second embodiment.

FIGS. 13A and 13B depict views illustrating examples of a warning screen to be displayed on a UI unit of the information processing apparatus according to the second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

### First Embodiment

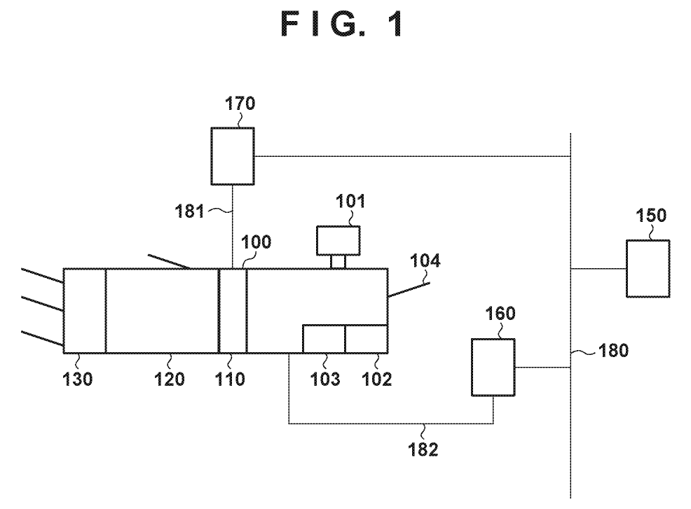

FIG. 1 depicts a view for describing the configuration of an inspection system including an inspection apparatus 170 according to the first embodiment of the present disclosure. This inspection system includes an image forming apparatus 100, an inspection unit 110, a large-volume stacker 120, a finisher 130, a client PC 150, an information processing apparatus 160, and the inspection apparatus 170. The image forming apparatus 100 is connected to the information processing apparatus 160 via a communication cable 182.

The image forming apparatus 100 includes a UI unit (operation panel) 101, a sheet feeding deck 102, and a sheet feeding deck 103. The image forming apparatus 100 further includes a manual feed unit 104. The image forming apparatus 100 performs printing on a recording medium such as a sheet based on various input data, for example, print data sent from the client PC 150 or the information processing apparatus 160.

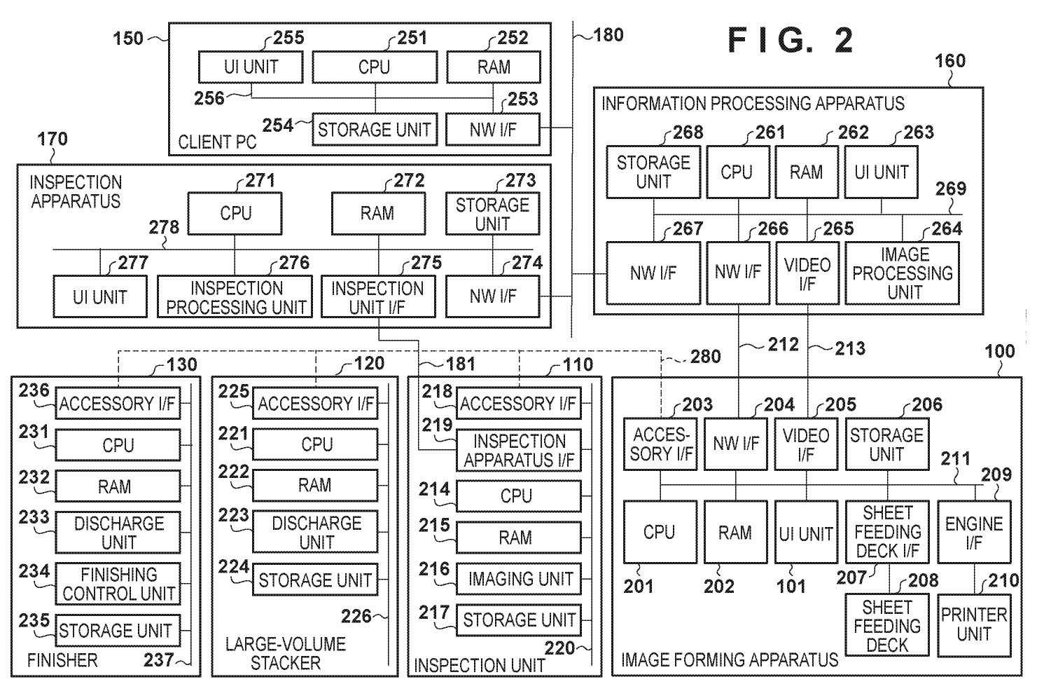

The image forming apparatus 100 includes the inspection unit 110, the large-volume stacker 120, and the finisher 130, and is connected to the inspection unit 110, the large-volume stacker 120, and the finisher 130 via a communication cable 280 (FIG. 2).

In the first embodiment, the image forming apparatus 100 will be described, but the present disclosure is not limited to this, and any printing apparatus that performs printing on a recording medium may be adopted. For example, an apparatus that performs printing on metal may be adopted. The image forming apparatus 100 of the first embodiment will be described with an example of a printing apparatus that performs printing on a sheet cut into a standard size, but may be a continuous form printing apparatus that performs printing on roll paper, for example. In that case, this inspection system may be an inspection system that performs inspection on a sheet after printing on roll paper and then cutting by a cutting machine.

The inspection unit 110 receives the printed matter output from the image forming apparatus 100, and obtains image data for inspecting whether or not there is a defect in the received printed matter. Here, an image defect degrades the quality of the printed matter. Examples of image defect include a defective image (spot) having a round shape caused by a color material adhering to an unintended portion at the time of printing, color omission caused by a sufficient color material not adhering to an intended portion, and a defective image (streak) having a linear shape.

The inspection apparatus 170 receives image data (scanned image) generated by the inspection unit 110 scanning the printed matter, and inspects an image of the printed matter based on the scanned image. This inspection includes, in addition to the above-described print image inspection, the inspection for inspecting a variable region part in variable printing including the variable region part such as a character string or a barcode. For example, it is possible to perform data legibility inspection for checking whether the character string or the barcode can be read or data collating inspection for collating a scanning result of the character string or the barcode with correct data. Other than this, inspection such as sequential number inspection for inspecting continuity of data, front and back coincidence inspection as to whether data such as the character string or the barcode coincides on the front and back, and color variation inspection for inspecting color variation between pages or between copies may be possible.

The inspection unit 110 transfers obtained image data to the inspection apparatus 170 via a communication cable 181, causes the inspection apparatus 170 to perform inspection as to whether or not the printed matter has a defective image on the inspection apparatus 170, and obtains the inspection result from the inspection apparatus 170. Note that in the embodiment, the inspection apparatus 170 and the inspection unit 110 are separated from each other, but the present disclosure is not limited to this, and they may be integrated into one inspection apparatus.

The large-volume stacker 120 is a stacker that can stack a large volume of sheets. The large-volume stacker 120 can receive the printed matter inspected by the inspection unit 110, and switch a conveyance path of the printed matter based on the inspection result of the printed matter in the inspection apparatus 170 to convey it.

The finisher 130 switches the discharge destination of the printed matter based on the inspection result of the inspection apparatus 170, executes post-processing (binding, stapling, and the like) on the printed matter as necessary, and discharges it.

The image forming apparatus 100 is connected to the client PC 150 and the information processing apparatus 160 via a network 180. Other than to the image forming apparatus 100, the inspection unit 110 is also connected to the large-volume stacker 120 and the finisher 130 via the communication cable 280. In the first embodiment, as an example, an inline inspection machine that performs image formation, inspection, post-processing, and sheet discharge from start to finish will be described, but there is no intention to limit the present disclosure.

FIG. 2 is a block diagram for describing a hardware configuration of the image forming apparatus 100, the inspection unit 110, the large-volume stacker 120, the finisher 130, the client PC 150, the information processing apparatus 160, and the inspection apparatus 170 according to the first embodiment.

First, the configuration of the client PC 150 will be described.

The client PC 150 is a PC for generating a print job and transmitting it to the information processing apparatus 160 via the network 180. The client PC 150 includes a CPU 251, a RAM 252, a network interface (hereinafter, NW I/F) 253, a storage unit 254, and a UI unit 255.

By deploying, into the RAM 252, and executing a program stored in the storage unit 254, the CPU 251 manages control and calculation of each unit in the client PC 150 via a system bus 256. The RAM 252 is a type of general volatile storage apparatus that can be directly accessed from the CPU 251, and is used as a work area of the CPU 251 and other temporary data storage regions. The NW I/F 253 transmits and receives data to and from the information processing apparatus 160 via the network 180. The storage unit 254 functions as a storage region of a program of the client PC 150, a temporary storage region at the time of operation, and a work memory. The UI unit 255 includes, for example, a keyboard, a pointing device, a display, and another input/output apparatus, and is used by the user to input various setting values or designation values.

Next, the configuration of the information processing apparatus 160 will be described.

The information processing apparatus 160 performs raster image processing (RIP) on print data and document data, and generates a bitmap image for performing printing by the image forming apparatus 100. Control regarding printing of the image forming apparatus 100 and a print job are managed. The information processing apparatus 160 includes a CPU 261, a RAM 262, a UI unit 263, an image processing unit 264, a video I/F 265, an NW I/F 266, an NW I/F 267, and a storage unit 268.

By deploying, into the RAM 262, and executing a program stored in the storage unit 268, the CPU 261 manages control and calculation of each unit in the information processing apparatus 160 via a system bus 269. The RAM 262 is a type of general volatile storage apparatus that can be directly accessed from the CPU 261, and is used as a work area of the CPU 261 and other temporary data storage regions. The UI unit 263 includes, for example, a keyboard, a pointing device, a display, and another input/output apparatus, and is used by the user to input various setting values or designation values.

The image processing unit 264 performs RIP processing of converting print data or document data transmitted from the client PC 150 into bitmap image data according to the usage purpose of the RIP processing and the print setting. Specifically, in the case of RIP processing for registering a reference image, for example, the resolution of 600 dpi is converted to 300 dpi to generate image data. On the other hand, in the case of RIP processing for print data, image data of 600 dpi is generated without reducing the resolution. In the RIP processing at the time of registration of a reference image, the image data subjected to the RIP processing is transferred to the inspection apparatus 170 via the network 180 and used as a reference image for inspection. On the other hand, in the RIP processing of print data at the time of inspection, the image data subjected to the RIP processing is transferred to the image forming apparatus 100 via the network 180 and used for print processing.

The video I/F 265 is connected to a video I/F 205 of the image forming apparatus 100 via a video cable 213, and manages communication of image data between the information processing apparatus 160 and the image forming apparatus 100. The NW I/F 266 is connected to an NW I/F 204 of the image forming apparatus 100 via a cable 212, and manages communication between the information processing apparatus 160 and the image forming apparatus 100. The communication cable 182 includes the cable 212 and the video cable 213. Note that this example shows a form in which interfaces connected to a system bus 211 and the system bus 269 are directly connected to each other, but a form in which the information processing apparatus 160 and the image forming apparatus 100 may be connected by a network or the like, for example, and the connection form thereof is not limited. The NW I/F 267 transmits and receives data to and from the client PC 150 via the network 180. The storage unit 268 functions as a storage region of a program, a temporary storage region at the time of operation of the information processing apparatus, and a work memory.

Next, the configuration of the image forming apparatus 100 will be described.

The image forming apparatus 100 performs print output based on various input data, for example, print data sent from the client PC 150 or the information processing apparatus 160. The image forming apparatus 100 is connected to the UI unit 101 and a sheet feeding deck 208. The image forming apparatus 100 includes a CPU 201, a RAM 202, an accessory I/F 203, the NW I/F 204, the video I/F 205, a storage unit 206, a sheet feeding deck I/F 207, and an engine I/F 209. The CPU 201 is connected to a printer unit 210 via the engine I/F 209.

By deploying, into the RAM 202, and executing a program stored in the storage unit 206, the CPU 201 manages control, calculation, and the like of each unit in the image forming apparatus 100 via the system bus 211. The RAM 202 is a type of general volatile storage apparatus that can be directly accessed from the CPU 201, and is used as a work area of the CPU 201 and other temporary data storage regions. The accessory I/F 203 is connected to an accessory I/F 218, an accessory I/F 225, and an accessory I/F 236 via the cable 280. That is, the image forming apparatus 100 mutually communicates with the inspection unit 110, the large-volume stacker 120, and the finisher 130 via the accessory I/Fs 203, 218, 225, and 236.

The NW I/F 204 is connected to the NW I/F 266 of the information processing apparatus 160 via the cable 212, and manages communication between the information processing apparatus 160 and the image forming apparatus 100. The video I/F 205 is connected to the video I/F 265 of the information processing apparatus 160 via the video cable 213, and manages communication of image data between the information processing apparatus 160 and the image forming apparatus 100. The storage unit 206 functions as a storage region of a program of the image forming apparatus 100, a temporary storage region of various data at the time of operation, and a work memory.

The sheet feeding deck I/F 207 manages control of and communication with the sheet feeding deck 208. The sheet feeding deck 208 collectively refers to the sheet feeding decks 102 and 103 and the manual feed unit 104 of FIG. 1 as a hardware configuration. The engine I/F 209 transmits print data to the printer unit 210.

Image data or document data created on the client PC 150 or the information processing apparatus 160 on the network 180 is transmitted as PDL data to the image forming apparatus 100 via a network (e.g., local area network). The transmitted PDL data is saved in the RAM 202 via the NW I/F 204. A print instruction by the user of the UI unit 101 is also saved in the RAM 202 through the system bus 211. The print instruction by the user includes, for example, selection of a sheet type.

The printer unit 210 prints print image data onto a recording sheet using a color material. The CPU 201 issues an instruction to the printer unit 210 based on the print instruction by the user saved in the RAM 202. For example, in the case where there is an instruction for printing with a coated sheet from the user, the CPU 201 issues an instruction to the printer unit 210 to output a sheet from the sheet feeding deck storing the coated sheet in the image forming apparatus 100. Various types of processing from reception of the PDL data described above to printing onto a sheet are controlled by the CPU 201, whereby a full-color toner image is formed on the sheet.

Next, the configuration of the inspection unit 110 will be described.

The inspection unit 110 performs control for transferring image data obtained by an imaging unit 216 to the inspection apparatus 170 described later via the communication cable 181. Then, the inspection result is obtained from the inspection apparatus 170 and transmitted to the image forming apparatus 100, the large-volume stacker 120, and the finisher 130.

The inspection unit 110 includes a CPU 214, a RAM 215, the imaging unit 216, a storage unit 217, the accessory I/F 218, and an inspection apparatus I/F 219. By deploying, into the RAM 215, and executing a program stored in the storage unit 217, the CPU 214 manages control, calculation, and the like of each unit in the inspection unit 110 via a system bus 220. The RAM 215 is a type of general volatile storage apparatus that can be directly accessed from the CPU 214, and is used as a work area of the CPU 214 and other temporary data storage regions.

The imaging unit 216 is an imaging unit that scans the printed matter conveyed from the image forming apparatus 100. The imaging unit 216 generates a scanned image by scanning the printed matter. The storage unit 217 functions as a storage region of a program of the inspection unit 110, a temporary storage region of data at the time of operation, and a work memory. The accessory I/F 218 is connected to the accessory I/Fs 203, 225, and 236 via the cable 280.

The inspection apparatus I/F 219 communicates with the inspection apparatus 170 via the communication cable 181, and communicates data such as a scanned image scanned by the imaging unit 216 and the inspection result.

Next, the configuration of the large-volume stacker 120 will be described.

The large-volume stacker 120 receives the printed matter inspected by the inspection unit 110, and switches the conveyance path thereof based on the result of the inspection apparatus 170 to convey it. For example, in the case where the discharge destination is switched depending on the inspection result as to whether there is a defect in the printed matter, the printed matter without the defect is discharged to a stack unit, and the printed matter with the defect is discharged to a discharge tray. The large-volume stacker 120 includes a CPU 221, a RAM 222, a discharge unit 223, a storage unit 224, and the accessory I/F 225. By deploying, into the RAM 222, and executing a program stored in the storage unit 224, the CPU 221 manages control, calculation, and the like of each unit in the large-volume stacker 120 via a system bus 226. The RAM 222 is a type of general volatile storage apparatus that can be directly accessed from the CPU 221, and is used as a work area of the CPU 221 and other temporary data storage regions. The discharge unit 223 performs control of conveying the conveyed printed matter to a stack tray, an escape tray, or a subsequent accessory based on an instruction from the CPU 221. The storage unit 224 functions as a storage region of a program of the large-volume stacker 120, a temporary storage region of data at the time of operation, and a work memory. The accessory I/F 225 is connected to the accessory I/Fs 203, 218, and 236 via the cable 280.

Next, the configuration of the finisher 130 will be described.

The finisher 130 includes a CPU 231, a RAM 232, a discharge unit 233, a finishing control unit 234, a storage unit 235, and the accessory I/F 236.

By deploying, into the RAM 232, and executing a program stored in the storage unit 235, the CPU 231 manages control and calculation of each unit in the finisher 130 via a system bus 237. The RAM 232 is a type of general volatile storage apparatus that can be directly accessed from the CPU 231, and is used as a work area of the CPU 231 and other temporary data storage regions. The finisher 130 is an apparatus for switching post-processing (e.g., binding or the like) according to print setting and switching a discharge destination based on the inspection result, on the conveyed printed matter. For example, in the case where the discharge destination is switched depending on the inspection result as to whether there is a defect in the printed matter, the printed matter without the defect is discharged to a normal output tray, and the printed matter with the defect is discharged to a tray different from the normal output tray. The discharge unit 233 controls conveyance and discharge of the sheet based on the instruction from the CPU 231. The finishing control unit 234 controls finishing processing such as stapling, punching, and saddle stitching based on the instruction from the CPU 231. The storage unit 235 functions as a storage region of a program of the finisher, a temporary storage region of data at the time of operation, and a work memory. The accessory I/F 236 is connected to the accessory I/Fs 203, 218, and 225 via the cable 280.

Next, the configuration of the inspection apparatus 170 will be described.

The inspection apparatus 170 is an apparatus for inspecting a scanned image of the printed matter obtained by the inspection unit 110. The inspection apparatus 170 includes a CPU 271, a RAM 272, a storage unit 273, an NW I/F 274, an inspection unit I/F 275, an inspection processing unit 276, and a UI unit 277. By deploying, into the RAM 272, and executing a program stored in the storage unit 273, the CPU 271 manages control and calculation of each unit in the inspection apparatus 170 via a system bus 278. The RAM 272 is a type of general volatile storage apparatus that can be directly accessed from the CPU 271, and is used as a work area of the CPU 271 and other temporary data storage regions. The storage unit 273 functions as a storage region of a program of the inspection apparatus 170, a temporary storage region of data at the time of operation, and a work memory. The NW I/F 274 transmits and receives data to and from the client PC 150 and the information processing apparatus 160 via the network 180. The inspection unit I/F 275 communicates with the inspection unit 110 via the communication cable 181, and communicates data such as a scanned image scanned by the inspection unit 110 and the inspection result. The inspection processing unit 276 inspects whether or not there is a defective part in the printed matter. The UI unit 277 is a UI unit for the user to set the inspection apparatus 170 and for displaying the inspection result to the user.

Note that here, the setting of the inspection apparatus 170 performed by the user is an item of what defect to inspect when inspecting the printed matter. The inspection item includes, for example, an inspection target such as a defective image (spot) having a round shape or a defective image (streak) having a linear shape. Note that in the first embodiment, the UI unit 277 of the inspection apparatus 170 includes a display unit that displays a screen and a display control unit that controls the screen to be displayed on the display unit. Regarding setting of the inspection apparatus 170, display of the inspection result, and the like to be performed by the UI unit 277, the UI unit 101 of the image forming apparatus 100 described above or an external apparatus such as an information processing apparatus (not illustrated) may be configured to perform display and reception of the instruction.

Next, the outline of print image inspection to be performed by the inspection apparatus 170 will be described.

The inspection apparatus 170 obtains a scanned image of the inspection target obtained by scanning the printed matter by the inspection unit 110, and the scanned image of the inspection target that is obtained is saved in the RAM 272.

Subsequently, the inspection apparatus 170 compares, by the inspection processing unit 276, the reference image saved in the RAM 272 as a correct image in advance with the scanned image of the inspection target to perform the inspection. Specifically, feature points are extracted from each of the reference image and the scanned image, and first, the reference image and the scanned image are aligned based on the extracted feature points. If the difference between the pixel value (luminance value) of the inspection target pixel in the scanned image aligned in this manner and the pixel value (luminance value) of the comparison target pixel in the reference image is a threshold or less, the inspection processing unit 276 determines that the inspection target pixel passes. Note that this threshold is different for each inspection level described later. This inspection proceeds by comparing each scanned image with the reference image corresponding thereto.

In this manner, when inspection of pixels for one scanned image ends, it is determined whether the total of the pixels determined to fail is the passing threshold or less, and based on this, it is determined whether or not the scanned image is normal. If the total of the pixels determined to fail is the passing threshold or less, the inspection processing unit 276 determines that the scanned image is normal. On the other hand, if the total of the pixels determined to fail in a certain region exceeds the passing threshold, the inspection processing unit 276 determines the region of the scanned image as a defective part. The result of inspection thus performed is saved in the RAM 272. This inspection result includes, for example, information on whether or not there is a defective part in the printed matter, the type (spot or streak) of the detected defective part, and position information on the defective part when displayed on the UI unit 277.

Next, the inspection apparatus 170 instructs the UI unit 277 to display the inspection result saved in the RAM 272 by the CPU 271. The user recognizes the inspection result by the inspection result being displayed on the UI unit 277.

In the case where a certain amount of printed matter having a defective part is produced continuously, the inspection apparatus 170 transmits the above information to the inspection unit 110 via the inspection unit I/F 275 by the CPU 271. When the CPU 214 of the inspection unit 110 receives, via the inspection apparatus I/F 219, the information that printed matter having a defective part was produced continuously, the CPU 214 transmits the information to the image forming apparatus 100 via the accessory I/F 218.

By this, upon receiving this information via the accessory I/F 203, the CPU 201 of the image forming apparatus 100 instructs the printer unit 210 to stop printing. The printer unit 210 is instructed to stop printing in this manner, whereby the image forming apparatus 100 stops the printing operation.

Furthermore, the inspection unit 110 also transmits information also to the large-volume stacker 120 and the finisher 130 via the accessory I/F 218 by the CPU 214. The information to be transmitted to the large-volume stacker 120 and the finisher 130 includes information on whether or not there is a defective part in the printed matter. Using the received information, the large-volume stacker 120 and the finisher 130 are able to discharge the printed matter without the defective part and the printed matter including the defective part to discharge destinations different from each other.

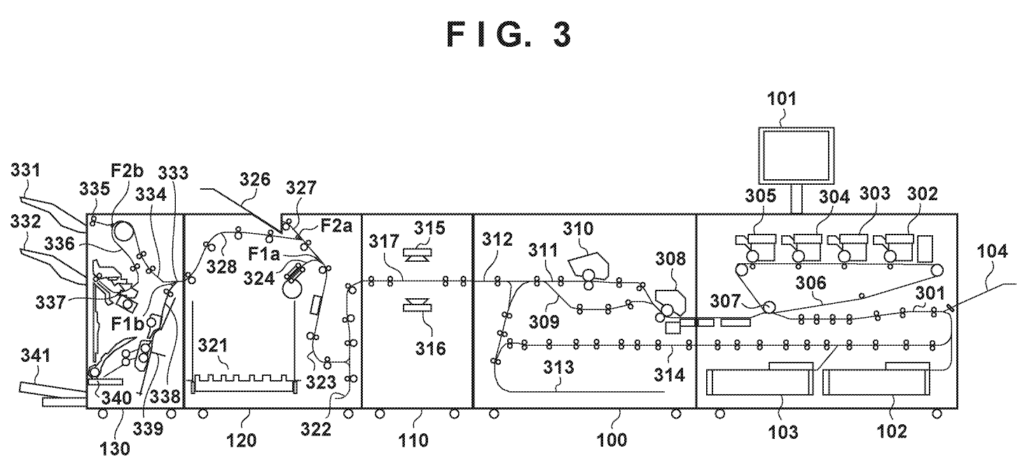

FIG. 3 depicts a schematic cross-sectional view describing the mechanisms of the image forming apparatus 100, the inspection unit 110, the large-volume stacker 120, and the finisher 130 according to the first embodiment.

The image forming apparatus 100 receives the user input via the UI unit 101, and displays the state of printing and equipment. The sheet feeding decks 102 and 103 and the manual feed unit 104 can store various sheets. Each of the sheet feeding decks can separate and convey, to a sheet conveyance path 301, only the uppermost one sheet of the stored sheets. In order to form a color image, development stations 302 to 305 form toner images using color toners of Y, M, C, and K, respectively. The toner images formed here are superimposed on an intermediate transfer belt 306 to be primary-transferred to form a color image on the intermediate transfer belt 306. The intermediate transfer belt 306 rotates clockwise in FIG. 3, and the color image is transferred to the sheet conveyed from the sheet conveyance path 301 at a secondary-transfer position 307. A fixing unit 308 includes a pressing roller and a heating roller, and when the sheet passes through between these rollers, the toner is melted and pressed, thereby fixing the color image onto the sheet. The sheet having passed through the fixing unit 308 is conveyed to a conveyance path 312 through a sheet conveyance path 309. In the case where further melting and pressing are required for fixing depending on the sheet type, after passing through the fixing unit 308, the sheet is conveyed to a second fixing unit 310 using the upper sheet conveyance path, subjected to additional melting and pressing, and then conveyed to the conveyance path 312 through a sheet conveyance path 311. In the case where the image forming mode is double-sided, the fixed sheet is conveyed to a sheet reversing path 313, reversed in the sheet reversing path 313, and then conveyed to a double-sided conveyance path 314, and image transfer to a second surface is performed at the secondary-transfer position 307. Note that in the following description, the printed matter on which the toner image is fixed may be simply called a sheet.

In the inspection unit 110, CISs 315 and 316 are disposed so as to face each other. The CIS 315 is a sensor configured to read the upper surface of the sheet, and the CIS 316 is a sensor configured to read the lower surface of the sheet. The inspection unit 110 scans the sheet using the CISs 315 and 316 at timing when the sheet conveyed to a sheet conveyance path 317 reaches a predetermined position. Image data obtained by the scanning is transmitted to the inspection apparatus 170 via the inspection apparatus I/F 219 and the inspection unit I/F 275. The CPU 271 of the inspection apparatus 170 determines whether there is a defect in the received image data, and notifies the inspection unit 110 of the determination result again via the inspection unit I/F 275 and the inspection apparatus I/F 219. The CPU 214 of the inspection unit 110 notifies the large-volume stacker 120 and the finisher 130 of the received determination result via the accessory I/Fs 218, 225, and 236.

The large-volume stacker 120 includes a stacker 321 as a tray on which sheets are stacked. The sheet having passed through the inspection unit 110 enters a sheet conveyance path 323 of the large-volume stacker 120 through the sheet conveyance path 317. The sheet conveyance path 323 branches into a sheet conveyance path 324 and a sheet conveyance path 325 at the branch position where a flapper F1a is installed. The sheet conveyed through the sheet conveyance path 323 is guided to the sheet conveyance path 324 or the sheet conveyance path 325 by the flapper F1a. For example, the flapper F1a guides the conveyed sheet to the sheet conveyance path 324 or the sheet conveyance path 325 depending on pass or fail of the inspection. A stacker 321 is provided at the exit of the sheet conveyance path 324. When discharging the sheet to the stacker 321, it is possible to shift, by a shift mechanism that is not illustrated, the sheet in a main scanning direction to discharge it. For example, depending on pass or fail of the inspection, it is possible to separate sheets conveyed to the sheet conveyance path 324 into sheets that pass the inspection and sheets that fail the inspection by shifting them in the main scanning direction and discharging them. This function is referred to as a shift (horizontal) mode. Here, the main scanning direction is the direction orthogonal to the conveyance direction of the sheet. When discharging the sheet to the stacker 321, it is possible to shift the sheet in a sub-scanning direction to discharge it by increasing the discharge speed by a discharge roller that is not illustrated. By this, for example, depending on pass or fail of the inspection, it is possible to separate sheets conveyed to the sheet conveyance path 324 into sheets that pass the inspection and sheets that fail the inspection by shifting them in the sub-scanning direction and discharging them. This function is referred to as a shift (vertical) mode. Here, the sub-scanning direction is the conveyance direction of the sheet.

The sheet conveyance path 325 branches into a sheet conveyance path 327 and a sheet conveyance path 328 at the branch position where a flapper F2a is installed. The sheet conveyed through the sheet conveyance path 325 is guided to the sheet conveyance path 327 or the sheet conveyance path 328 by the flapper F2a. For example, the flapper F2a guides the conveyed sheet to the sheet conveyance path 327 or the sheet conveyance path 328 depending on pass or fail of the inspection. A stacker tray 326 is provided as a discharge tray at the exit of the sheet conveyance path 327. In a case where the sheet is conveyed to the subsequent stage of the large-volume stacker 120, the sheet is conveyed via the sheet conveyance path 328.

A reversing unit 322 for reversing the sheet is used in the case where the sheet is stacked on the stacker 321. The reversing unit 322 reverses the sheet once in the case of stacking the sheet onto the stacker 321 such that the orientation of the sheet when entering is identical to the orientation of the sheet when stacked. In the case of conveyance to the stacker tray 326, the sheet is discharged as it is without being flipped when stacked, so that the reversing unit 322 does not perform the reversing operation.

The finisher 130 performs finishing processing on the conveyed sheet in response to the function designated by the user. Specifically, the finisher 130 has finishing functions such as stapling (one-point/two-point binding), punching (two-hole/three-hole), and saddle stitching. The finisher 130 includes two discharge trays 331 and 332. The sheet having passed through the large-volume stacker 120 enters the finisher 130 through a sheet conveyance path 333.

The sheet conveyance path 333 branches into a sheet conveyance path 334 and a sheet conveyance path 338 at the branch position where a flapper F1b is arranged. The sheet conveyed through the sheet conveyance path 333 is guided to the sheet conveyance path 334 or the sheet conveyance path 338 by the flapper F1b. For example, the flapper F1b guides the conveyed sheet to the sheet conveyance path 334 or the sheet conveyance path 338 based on pass or fail of the inspection.

The sheet conveyance path 334 branches into a sheet conveyance path 335 and a sheet conveyance path 336 at the branch position where a flapper F2b is arranged. The sheet conveyed through the sheet conveyance path 334 is guided to the sheet conveyance path 335 or the sheet conveyance path 336 by the flapper F2b. For example, the flapper F2b guides the conveyed sheet to the sheet conveyance path 335 or the sheet conveyance path 336 according to pass or fail of the inspection.

A discharge tray 331 is provided at the exit of the sheet conveyance path 335. When discharging the sheet to the discharge tray 331, it is possible to discharge the sheet in the shift (horizontal) mode and the shift (vertical) mode by the shift mechanism and the discharge roller that are not illustrated. However, finishing processing such as stapling cannot be performed in the sheet conveyance path 335. In the case where finishing processing such as stapling is performed, the sheet is sent to a processing unit 337 via the sheet conveyance path 336, where the finishing function designated by the user is executed, and the sheet is output to the discharge tray 332. When discharging the sheet to the discharge tray 332, similarly to the discharge tray 331, it is possible to discharge the sheet in the shift (horizontal) mode and the shift (vertical) mode by the shift mechanism and the discharge roller that are not illustrated.

Each of the discharge trays 331 and 332 is able to be elevated and lowered, and it is possible to lower the discharge tray 331 and it is possible to operate so as to stack the sheet subjected to the finishing processing by the processing unit 337 onto the discharge tray 331. In the case where saddle stitching is designated, after a saddle stitch processing unit 339 performs stapling processing on the sheet center, the sheet is folded in two and output to a saddle stitching tray 341 via a sheet conveyance path 340. The saddle stitching tray 341 has a belt conveyor configuration, and the saddle stitching bundle stacked on the saddle stitching tray 341 is conveyed to the left side.

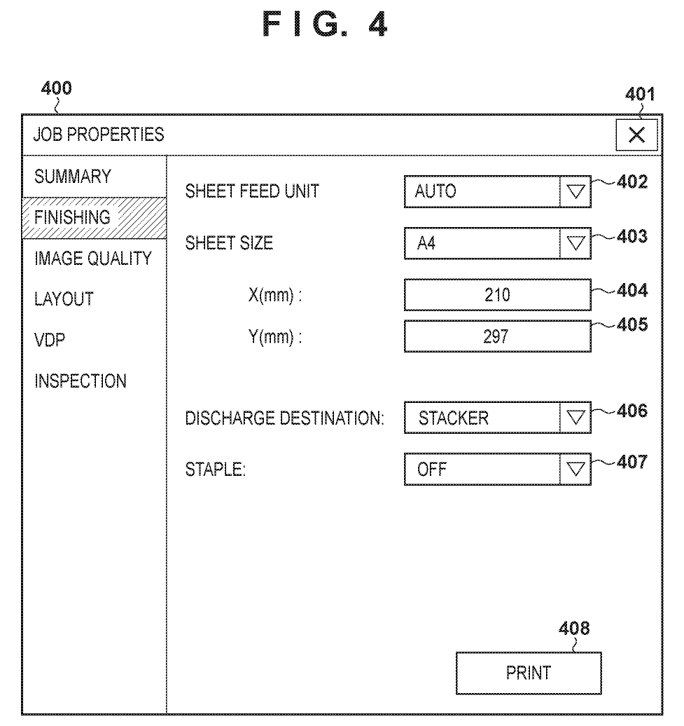

Next, print setting according to the embodiment will be described with reference to FIG. 4.

FIG. 4 depicts a view illustrating an example of a job property screen 400 to be displayed on the UI unit 263 of the information processing apparatus 160 according to the first embodiment.

The job property screen 400 is a screen for receiving print job setting from the user in the information processing apparatus 160. In FIG. 4, the finishing button is selected to be displayed as a setting screen of finishing processing.

A sheet feeder setting section 402 is used to select a sheet feed unit storing sheets to be used for printing. In the case where "auto" is set as in FIG. 4, the sheet feed unit storing sheets set by a sheet size setting section 403 is automatically selected.

The sheet size setting section 403 sets a standard sheet size such as A4 or B3, for example. In the case where a long sheet or the like is used, "nonstandard" is set, and vertical and horizontal sizes of the sheet are designated in a horizontal size setting section 404 and a vertical size setting section 405 of a nonstandard size. In FIG. 4, the standard "A4" size is set. In this case, the horizontal size and the vertical size of the standard size may be displayed in the horizontal size setting section 404 and the vertical size setting section 405 as in FIG. 4, but need not be displayed.

In the first embodiment, a discharge destination setting section 406 is selected from the stacker 321, the stacker tray 326, the discharge tray 331, the discharge tray 332, and the saddle stitching tray 341. In the example of FIG. 4, "stacker", which indicates the stacker 321 of the large-volume stacker 120, is set. A staple setting section 407 designates existence or absence of stapling by the finisher 130 and the position where stapling is performed. In the example of FIG. 4, "OFF", which indicates no stapling, is set. Finally, when a print button 408 is pressed, printing and inspection operations are executed based on the setting that is input. When a close button 401 is pressed, the screen 400 is closed without saving the setting of this screen, and the screen transitions to the original screen.

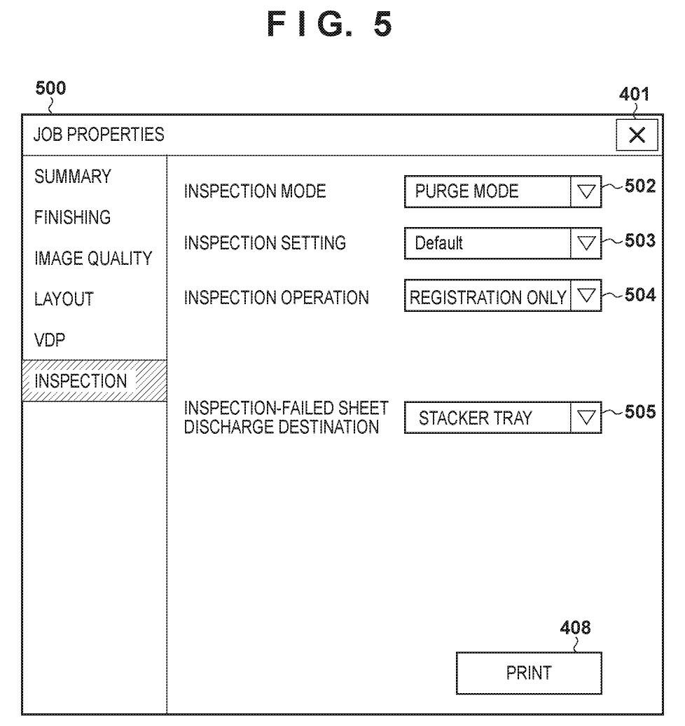

Next, the setting of an inspection job according to the present embodiment will be described with reference to FIG. 5.

FIG. 5 depicts a view illustrating an example of a job property screen 500 to be displayed on the UI unit 263 of the information processing apparatus 160 according to the first embodiment.

The job property screen 500 is a screen on which the inspection button is selected and the information processing apparatus 160 receives inspection operation setting from the user. In FIG. 5, "purge mode" is set in an inspection mode setting section 502.

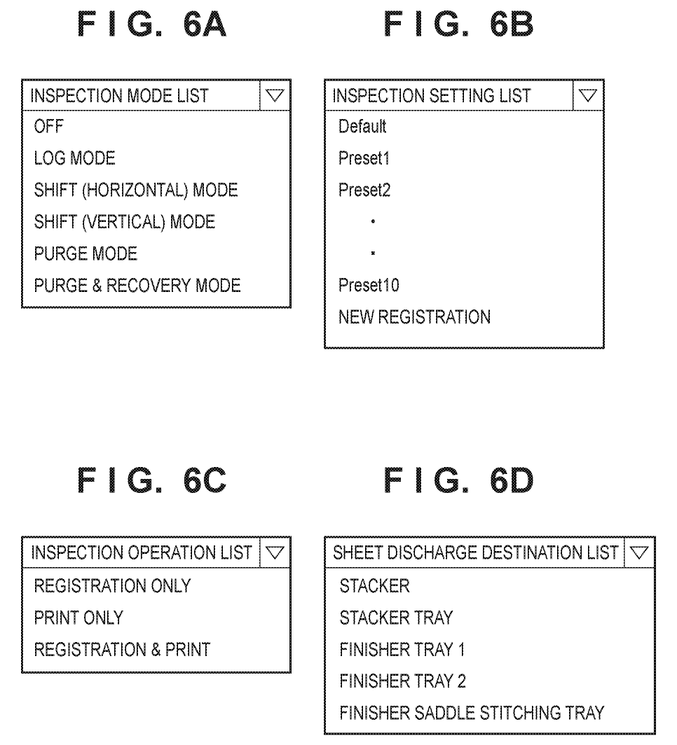

FIG. 6A depicts a view illustrating the list of selection items of the inspection mode to be displayed on the inspection mode setting section 502.

In the case where the user selects "OFF", the print job is treated as a normal print job in which no inspection is performed. The print job selected by the user other than "OFF" is "inspection job". When the user selects "log mode", the sheet for which inspection is OK and the sheet for which inspection is NG are discharged to the same discharge destination, regardless of the inspection result of the inspection apparatus 170.

In the case where the user selects "shift (horizontal) mode" in the inspection mode setting section 502, the sheet for which inspection is OK in the inspection result of the inspection apparatus 170 and the sheet for which inspection is NG are discharged to the same discharge destination. Then, the sheet for which inspection is NG is discharged in the state of being shifted in the main scanning direction with respect to the sheet for which inspection is OK.

In the case where the user selects "shift (vertical) mode" in the inspection mode setting section 502, the sheet for which inspection is OK in the inspection result of the inspection apparatus 170 and the sheet for which inspection is NG are discharged to the same discharge destination. Furthermore, the sheet for which inspection is NG is discharged in the state of being shifted in the sub-scanning direction by being discharged at an accelerated speed with respect to the sheet for which inspection is OK. The shift (horizontal) mode and the shift (vertical) mode are collectively called a "shift operation mode".

In the case where the user selects "purge mode" as in FIG. 5 in the inspection mode setting section 502, the sheet for which inspection is OK in the inspection result of the inspection apparatus 170 and the sheet for which inspection is NG are discharged to different discharge destinations. In the case where the user selects "purge & recovery mode" in the inspection mode setting section 502, the sheet for which inspection is OK in the inspection result of the inspection apparatus 170 and the sheet for which inspection is NG are discharged to different discharge destinations. Furthermore, at the time point when the inspection apparatus 170 determines that the inspection result is NG, all the subsequent sheets that have already been fed and are present in an apparatus such as the image forming apparatus 100 and the inspection unit 110 are discharged to the same discharge destination as that of the sheet for which inspection is NG. Thereafter, after the sheet is no longer present in the sheet conveyance path, the image forming apparatus 100 and the inspection apparatus 170 resume printing and inspection from the image scheduled to be printed on the sheet for which inspection is NG. The "purge mode" and the "purge & recovery mode" are collectively called a "purge operation mode".

Next, the user selects the region to be inspected and the setting method of the inspection level thereof in an inspection setting section 503.

FIG. 6B depicts a view illustrating the list of selection items of the inspection setting to be displayed in the inspection setting section 503.

In the case where "Default" is selected as illustrated in FIG. 5, the inspection apparatus 170 inspects the entire surface of the inspection target image at the standard level. In the case where any of "Preset 1" to "Preset 10" is selected, the inspection apparatus 170 performs inspection based on the inspection region (inspection target region) and the inspection level set in advance for the selected item. In the case where "new registration" is selected, the user newly creates an inspection setting, and the inspection apparatus 170 performs inspection based in the inspection setting.

The user selects registration of the reference image and the combination of printing operations of the print job by an inspection operation setting section 504.

FIG. 6C depicts a view illustrating the list of selection items of the inspection operation to be displayed on the inspection operation setting section 504.

In the case where the user selects "registration only", the inspection apparatus 170 only performs registration of the reference image and the inspection setting thereof. In the case where "print only" is selected, printing by the image forming apparatus 100 and inspection by the inspection apparatus 170 are performed using the reference image registered in advance. In the case where "registration & print" is selected, the operation of "registration only" described above, that is, the registration of the reference image and the operation of "print only" are continuously performed. In the first embodiment, a case where an RIP image is used as a reference image will be described, but the present disclosure is not limited to this, and for example, the scanned image scanned by the imaging unit 216 printed by the image forming apparatus 100 may be used as a reference image.

The user can set the discharge destination of the sheet determined to fail in the inspection by an inspection-failed sheet discharge destination setting section 505 in FIG. 5.

FIG. 6D depicts a view illustrating the list of selection items of the discharge destination to be displayed in the inspection-failed sheet discharge destination setting section 505.

In the case where the user selects "stacker", the sheet determined to fail in the inspection is discharged to the stacker 321 of the large-volume stacker 120. In the case where the user selects "stacker tray" as in FIG. 5, the sheet determined to fail in the inspection is discharged to the stacker tray 326 of the large-volume stacker 120. In the case where the user selects "finisher tray 1", the sheet determined to fail in the inspection is discharged to the discharge tray 331 of the finisher 130. In the case where the user selects "finisher tray 2", the sheet determined to fail in the inspection is discharged to the discharge tray 332 of the finisher 130. Furthermore, in the case where the user selects "finisher saddle stitching tray", the sheet determined to fail in the inspection is discharged to the saddle stitching tray 341 of the finisher 130.

Finally, when the user presses the print button 408, printing and inspection operations are executed based on the setting input on this screen 500. When the close button 401 is pressed, the screen is closed without saving the setting of the present screen.

Next, the flow of job property setting processing in the information processing apparatus 160 according to the first embodiment will be described.

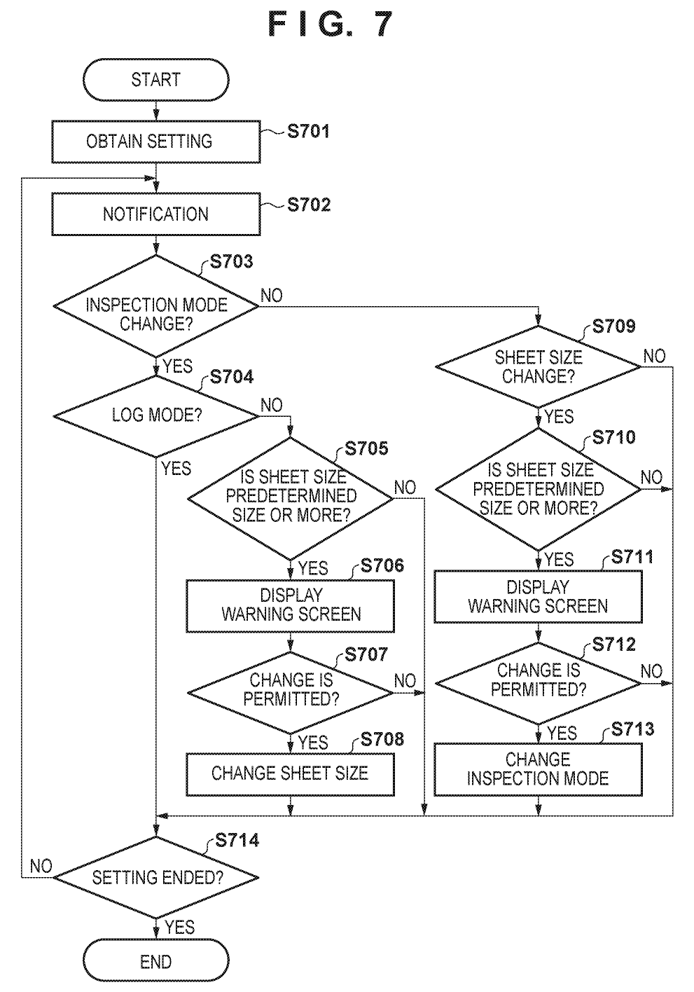

FIG. 7 is a flowchart for describing print setting processing by the information processing apparatus 160 according to the first embodiment. The processing shown in this flowchart is implemented by the CPU 261 of the information processing apparatus 160 deploying, into the RAM 262, the program code stored in the storage unit 268, and reading and executing the deployed program code.

First, in step S701, the CPU 261 obtains setting information on the job property screen from the storage unit 268 at the timing when the above-described job property screen is displayed, for example. Here, for example, it is assumed that, as initial values, the sheet size is set to A4 in the sheet size setting section 403 as illustrated in FIG. 4, and the inspection mode is set to "purge mode" in the inspection mode setting section 502 as illustrated in FIG. 5. However, the present disclosure is not limited to this, and other sheet sizes and inspection modes may be set.

Next, the processing proceeds to step S702, and the CPU 261 receives the content of the user UI operation from the UI unit 263. Then, the processing proceeds to step S703, and the CPU 261 determines whether or not the user UI operation is a change to the inspection mode. Here, if determining that an inspection mode change is made, the processing proceeds to step S704, and if determining that no inspection mode change is made, the processing proceeds to step S709.

In step S704, the CPU 261 determines whether the changed inspection mode is "log mode". Here, if determining that the change to "log mode" is made, the processing proceeds to step S714, and in the case of a mode other than the log mode, for example, the mode of purging or the mode of shifting, the processing proceeds to step S705.

In step S705, the CPU 261 determines whether the sheet size set in the sheet size setting section 403 is a predetermined size or more. For example, in the case of a sheet whose length in the sub-scanning direction (conveyance direction) of the sheet size is longer than a predetermined length, such as a long sheet, a case where the sheet is longer than the conveyance distance (length of the conveyance path) from the CIS sensors 315 and 316 to the flapper F1a is conceivable. In this case, the leading end of the sheet reaches the flapper F1a before the inspection result of the sheet is known. As a result, the discharge destination of the sheet cannot be switched between the stacker 321 and a discharge destination downstream of the stacker 321 depending on the inspection result. Similarly, a case where the length in the conveyance direction of the sheet is longer than the conveyance distance from the CIS sensors 315 and 316 to the flapper F2a is conceivable. In this case, the leading end of the sheet reaches the flapper F2a before the inspection result of the sheet is known. As a result, the discharge destination of the sheet cannot be switched between the stacker tray 326 and a discharge destination downstream of the stacker tray 326 depending on the inspection result.

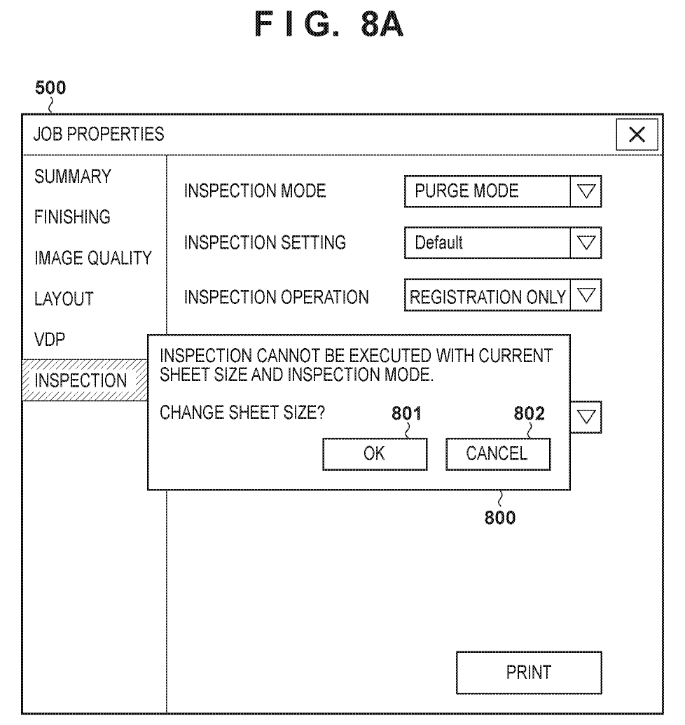

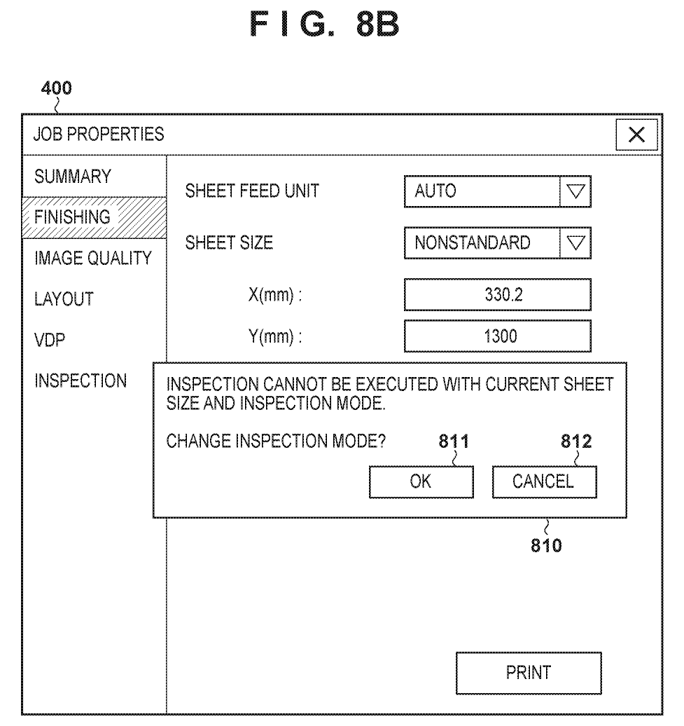

In the first embodiment, assuming that the length of the conveyance distance from the scanning position by the CIS sensors 315 and 316 to the flapper F2a is 800 mm, in the case where the length in the conveyance direction of the sheet exceeds 800 mm, the leading end of the sheet reaches the flapper F2a before the sheet inspection is completed. In the case where the discharge destination of the sheet for which inspection is OK is the stacker 321 and the discharge destination of the sheet for which inspection is NG is the stacker tray 326 in the purge mode, it is determined that the inspection cannot be performed and an error occurs in the case where the inspection result is not output before the flapper F2a. Therefore, in the first embodiment, in the case where the inspection mode for performing the purge operation or the shift operation is set, a warning is issued to change the sheet size or the inspection mode if the sheet size is the predetermined size or more. Therefore, the processing proceeds to step S706 to display a warning screen if determining that the sheet size is the predetermined size or more in step S705, and the processing proceeds to step S714 if the sheet size is less than the predetermined size. In step S706, the CPU 261 displays, on the UI unit 263, a warning screen 800 illustrated in FIG. 8A, for example.

FIG. 8A depicts a view illustrating an example of the warning screen 800 to be displayed in step S706.

This warning screen 800 is displayed as a pop-up on the job property screen 500 illustrated in FIG. 5, for example. Since the job property screen 500 presents a setting screen example of the inspection mode, the warning screen 800 asks whether to change the sheet size in order to execute the set inspection mode. An OK button 801 is pressed in the case of changing the sheet size, and a cancel button 802 is pressed in the case of not changing the sheet size.

Next, the processing proceeds to step S707, and the CPU 261 determines whether the change is permitted on the warning screen 800. Specifically, in the case of determining that the OK button 801 is pressed on the warning screen 800, the CPU 261 determines that the change of the sheet size is permitted, and the processing proceeds to step S708. On the other hand, in the case of determining that the cancel button 802 is pressed on the warning screen 800, the CPU 261 determines that the change of the sheet size is not permitted, and the processing returns the sheet size to the setting before the change notification in step S702, and proceeds to step S714.

In step S708, the CPU 261 changes the sheet size to a size less than the predetermined size, and the processing proceeds to step S714. For example, let the length in the conveyance direction of the sheet be L, and let the distance from the CIS sensors 315 and 316 to the flapper F2a be D, the inspection cannot be performed with a sheet size of D < L if the inspection mode is changed to a mode other than the log mode. Therefore, in such a case, a sheet size satisfying D > L is set. Alternatively, an inspection time T that can be used for inspection is T = (D - L)/S when the conveyance speed of the sheet is S. Based on this, a sheet size that can secure the inspection time T may be set. Alternatively, a sheet of a standard size, for example, the A4 size may be selected from among sheet sizes that can secure the inspection time T.

When no inspection mode change is made in step S703, the processing proceeds to step S709, and the CPU 261 determines whether the user UI operation is the change of the sheet size. The processing proceeds to step S710 if determining that the sheet size is changed, and proceeds to step S714 if the operation is other than the sheet size. In step S710, the CPU 261 determines whether the changed sheet size is the predetermined size or more, similarly to step S705. Here, if determining that the sheet size is the predetermined size or more, the processing proceeds to step S711, and in the case where the sheet size is less than the predetermined size, the processing proceeds to step S714. In step S711, the CPU 261 displays, on the UI unit 263, a warning screen 810 illustrated in FIG. 8B, for example.

FIG. 8B depicts a view illustrating an example of the warning screen 810 to be displayed in step S711.

This warning screen 810 is displayed as a pop-up on the job property screen 400 illustrated in FIG. 4, for example. Since the job property screen 400 presents a setting screen example of the finishing processing including the sheet size, the warning screen 810 asks whether to change the inspection mode in order to execute the inspection mode with the selected sheet size. An OK button 811 is pressed in the case of changing the inspection mode, and a cancel button 812 is pressed in the case of not changing the inspection mode.

In step S712, the CPU 261 determines whether the change is permitted on the warning screen 810. Specifically, in the case of determining that the OK button 811 is pressed on the warning screen 810, the CPU 261 determines that the change of the inspection mode is permitted, and the processing proceeds to step S713. On the other hand, in the case where the cancel button 812 is pressed on the warning screen 810, the CPU 261 determines that the change of the inspection mode is not permitted, and the processing returns the inspection mode to the setting before the change notification in step S702, and proceeds to step S714.

In step S713, the CPU 261 changes the inspection mode to "log mode", and the processing proceeds to step S714. For example, let the length of the sheet be L, let the distance from the CIS sensors 315 and 316 to the flapper F2a be D, and let the conveyance speed be S, (D - L)/S is the inspection time that can be used in inspection in the purge mode. That is, the inspection time cannot be secured with a sheet size of D < L. On the other hand, in the case of the log mode, (L + SP)/S is the time that can be used for the inspection where the distance (sheet interval) from the rear end of the sheet (timing when scanning of the image is completed by the CIS sensor) to the rear end of the next sheet, that is, the gap between the sheets, is SP. In the case of D < L, there is no time that can be used for inspection in the purge mode, but inspection may be performed between the sheets in the case of the log only mode. Therefore, changing the inspection mode to the log mode enables inspection to be executed even on a sheet such as a long sheet.

In step S714, the CPU 261 determines whether the job property setting has ended. If the setting has not ended, the processing returns to step S702, and the CPU 261 receives the content of the user UI operation. In the case of determining that the job property setting has ended, the CPU 261 ends this processing. Here, for example, in the case where a save button (not illustrated) is pressed, the CPU 261 saves the setting of the job property screen in the storage unit 268, and ends this processing. Alternatively, when the print button 408 on the job property screen is pressed, the CPU 261 determines that the job property setting has ended, saves the setting of the job property screen in the storage unit 268, and ends this processing. Then, printing and inspection operations are executed based on the setting that is input. The above is the description regarding the job property setting processing.

Note that the warning screens 800 and 810 to be displayed in step S706 and step S711 of FIG. 7 may display the message "Setting cannot be made with the current sheet size and inspection mode. Please change the setting on the job property screen". In that case, when the OK button is pressed, the screen may transition to the job property screen illustrated in FIGS. 4 or 5 so that the user can change the sheet size or the inspection mode.

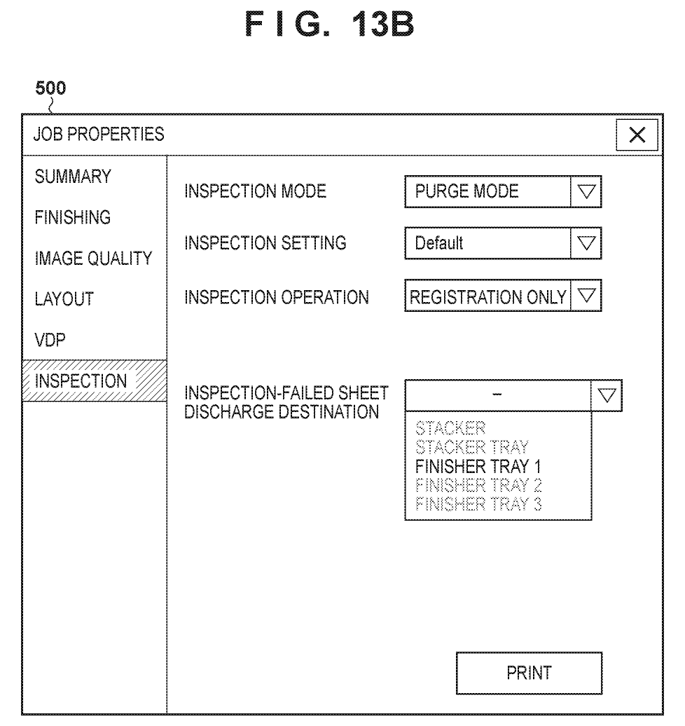

Alternatively, when the screen transitions to the job property screen, as in FIG. 13 described later, for example, a selectable inspection mode, a selectable sheet size, or the like may be displayed to allow the user to select.

In the first embodiment, the method of executing the processing of step S703 and subsequent steps upon receiving a notification of the UI operation in step S702 has been described. However, the present disclosure is not limited to this, and may adopt a configuration in which, for example, the sheet size and the inspection mode are determined when the setting value is acquired in step S701, and the warning screen illustrated in step S706 or step S711 may be displayed based on the determination result thereof.

Next, the flow of inspection processing in the inspection apparatus 170 according to the first embodiment will be described.

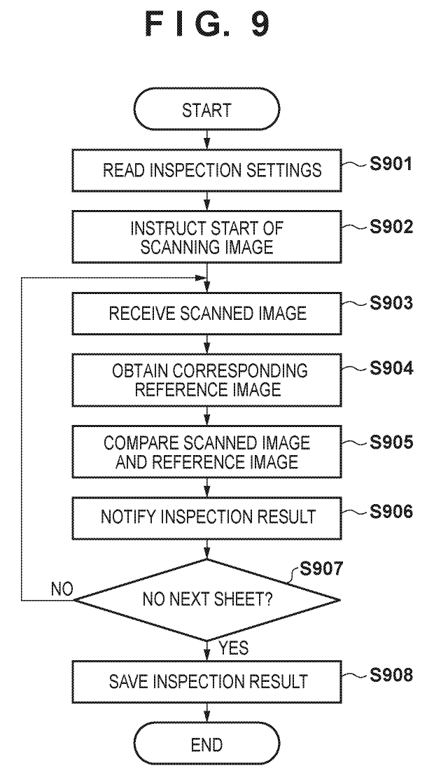

FIG. 9 is a flowchart for describing inspection processing by the inspection apparatus 170 according to the first embodiment. The processing shown in this flowchart is implemented by the CPU 271 of the inspection apparatus 170 deploying, into the RAM 272, the program code stored in the storage unit 273, and reading and executing the deployed program code.

In step S901, the CPU 271 reads the inspection settings saved in the storage unit 273. Next, the processing proceeds to step S902, and, upon receiving a start instruction for a print job from the information processing apparatus 160, the CPU 271 instructs the inspection unit 110 to start scanning the printed matter. Next, the processing proceeds to step S903, and the CPU 271 receives the scanned image obtained by the inspection unit 110 scanning the printed matter. Next, the processing proceeds to step S904, and the CPU 271 obtains the reference image corresponding to the scanned image, saved in the RAM 272. Then, the processing proceeds to step S905, and the CPU 271 performs alignment between the scanned image obtained in step S903 and the reference image obtained in step S904, and then compares them, thereby inspecting the scanned image. Then, the processing proceeds to step S906, and the CPU 271 notifies the inspection unit 110 of the inspection result. This inspection result is also notified to the large-volume stacker 120 and the finisher 130. The large-volume stacker 120 and the finisher 130 change the discharge destination of the sheet depending on the setting of the job property screen and the inspection result, and convey the sheet. The inspection result is displayed on the UI unit 277 of the inspection apparatus 170. Next, the processing proceeds to step S907, and the CPU 271 determines whether the scanning of the sheet has been completed. Here, in the case of determining that scanning of all the sheets designated in the job has not been completed, the processing returns to step S903, and the CPU 271 instructs scanning of the next printed matter. In the case of determining that scanning of all the printed matters has been completed, the processing proceeds to step S908. In step S908, the CPU 271 saves the inspection result into the RAM 272, and ends this processing. The above is the description regarding the inspection processing by the inspection apparatus 170.

As described above, according to the first embodiment, in the case where the size of the sheet of the inspection target is a predetermined size or more for which the discharge destination cannot be switched depending on the inspection result, for example, a state in which inspection cannot be performed can be avoided by changing the sheet size or the inspection mode.

### Second Embodiment

In the first embodiment described above, the method of avoiding a state in which inspection cannot be performed by changing the sheet size or the inspection mode in the case where the sheet size is a predetermined size or more has been described.

On the other hand, in the second embodiment, an example will be described in which a discharge destination to which the printed matter can be discharged is displayed according to the sheet size and the inspection mode, and the inspection mode is changed in the case where there is no discharge destination to which the printed matter can be discharged in the current inspection mode. Note that the configuration of the inspection system, the hardware configuration of each apparatus, and the like according to the second embodiment are similar to those of the first embodiment described above, and thus the description thereof will be omitted.

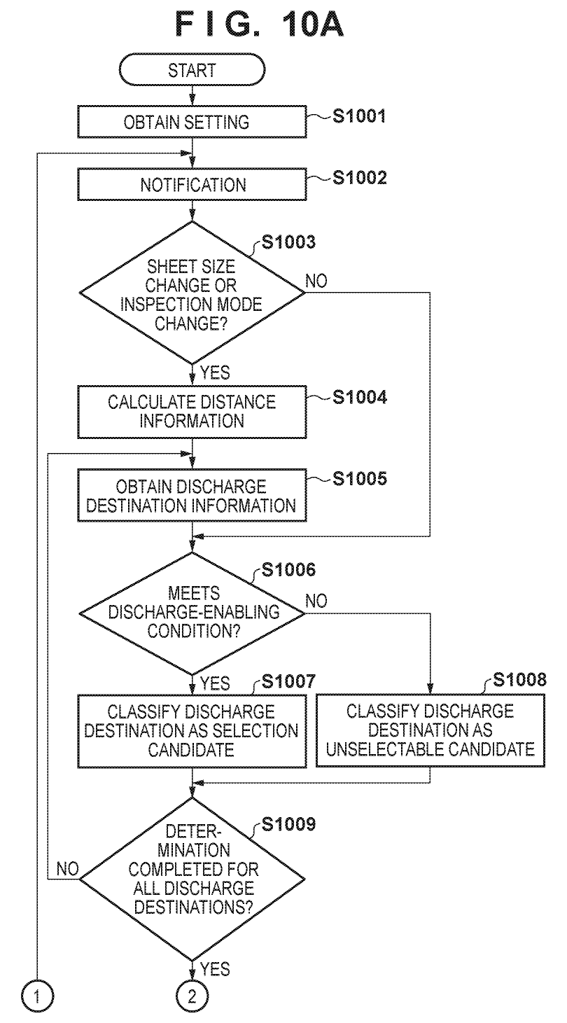

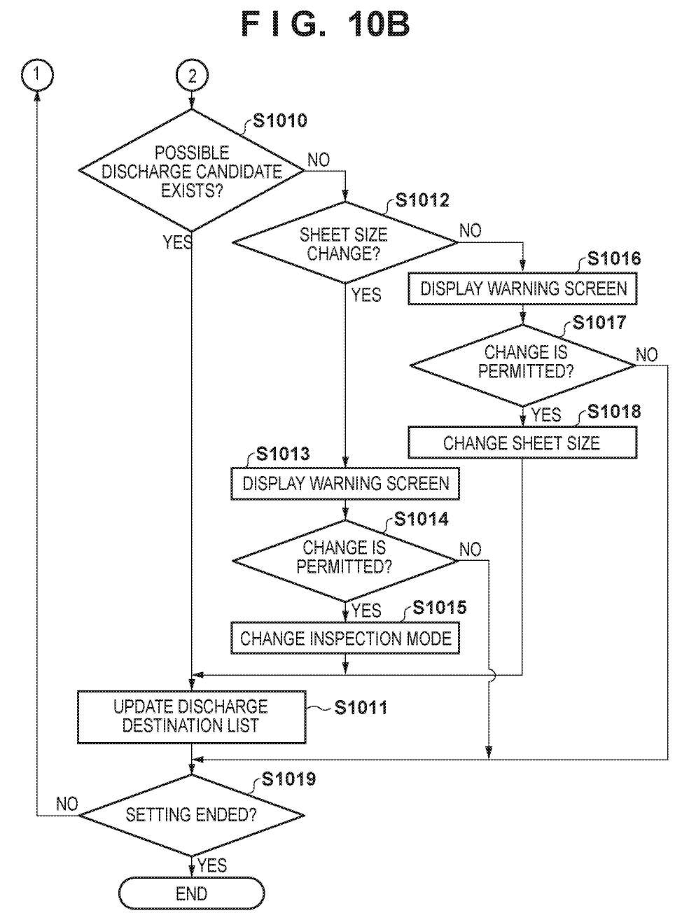

FIGS. 10A and 10B are flowcharts for describing job property setting processing by the information processing apparatus 160 according to the second embodiment. The processing shown in this flowchart is implemented by the CPU 261 of the information processing apparatus 160 deploying, into the RAM 262, the program code stored in the storage unit 268, and reading and executing the deployed program code.

In step S1001, the CPU 261 obtains, from the storage unit 268, the setting information set on the job property screen at the timing when the job property screen is displayed. Here, for example, it is assumed that, as initial values, the sheet size is set to A4 in the sheet size setting section 403, and the inspection mode is set to "purge mode" in the inspection mode setting section 502, but other sheet sizes and inspection modes may be set. Next, the processing proceeds to step S1002, and the CPU 261 receives a notification of a user operation via the UI unit 263. Then, the processing proceeds to step S1003, and the CPU 261 determines whether the user UI operation is the change of the sheet size or the change of the inspection mode. Here, the processing proceeds to step S1004 if determining that the sheet size or inspection mode change is made, and proceeds to step S1006 in the case of an operation other than the change of the sheet size or inspection mode.

In step S1004, the CPU 261 calculates the conveyance distance of the sheet necessary for the inspection, that is, from scanning of the sheet to outputting of the inspection result based on the sheet size set at the current time point. First, in order to calculate the conveyance distance, the inspection time T necessary for inspection is calculated. This inspection time T has a high correlation with the area of the inspection region. For example, in the case where the range to be inspected is wide, the time necessary for the inspection increases accordingly. Therefore, the inspection time T is obtained using a table or a mathematical expression defined in advance so that the inspection time T according to the sheet size is obtained. Alternatively, the area of the range to be inspected may be obtained, and the time T necessary for the inspection may be obtained using a table or a mathematical expression defined in advance. Next, the conveyance speed S of the sheet is obtained from the size and basis weight of the sheet. This may be obtained by referring to a table or a mathematical expression defined in advance. A sheet having a large basis weight has a lower conveyance speed than a sheet having a small basis weight. A sheet having a large sheet size requires more heat as fixing compared with a sheet having a small sheet size, and the conveyance speed S of the sheet decreases. Then, the conveyance distance of the sheet is calculated based on the time T necessary for the inspection and the conveyance speed S. This conveyance distance is obtained by (the inspection time T) × (the conveyance speed S).

Next, the processing proceeds to step S1005, and the CPU 261 obtains discharge destination information. Specifically, the CPU 261 obtains one from the discharge destination list illustrated in FIG. 6D.

Next, the processing proceeds to step S1006, and the CPU 261 determines whether the discharge destination selected in step S1005 meets the discharge-enabling condition from the conveyance distance calculated in step S1004, the discharge destination information obtained in step S1005, and the inspection mode of the inspection mode setting section 502. Determination processing in step S1006 will be described below.

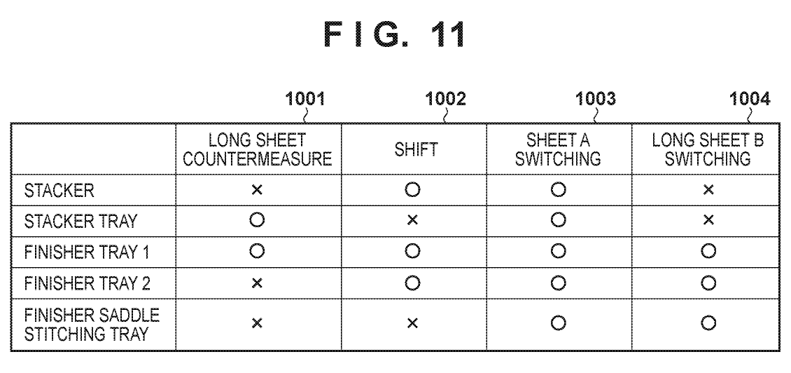

FIG. 11 depicts a view illustrating an example of a table that stores information for determining whether the discharge-enabling condition is met in accordance with the discharge destination information according to the second embodiment. "Long sheet B" is a sheet having a size exceeding the distance from the CIS sensor to the flapper F2a, and "sheet A" is a sheet having a size shorter than the distance from the CIS sensor to the flapper F1a.

A long sheet compatibility 1001 indicates whether the discharge destination is compatible with discharge of the long sheet. The case of being compatible with discharge of the long sheet is indicated by ○, and the case of being not compatible therewith is indicated by × (N/A). In the example of FIG. 11, only the stacker tray 326 of the large-volume stacker 120 and the discharge tray 331 of the finisher 130 are compatible with discharge of the long sheet.

A shift 1002 indicates whether the discharge destination is compatible with shift sorting. The case of being compatible with shift sorting is indicated by ○, and the case of being not compatible therewith is indicated by ×. In the example of FIG. 11, the stacker 321 of the large-volume stacker 120 and the discharge trays 331 and 332 of the finisher 130 are compatible with shift sorting.

Sheet A switching 1003 indicates the case of a sheet having a size shorter than the distance from the CIS sensor to the flapper F1a, and is registered as being dischargeable to any discharge destination. Long sheet B switching 1004 is for a sheet having a size exceeding the distance from the CIS sensor to the flapper F2a, and therefore it is impossible to switch the discharge destination to the stacker 321 and the stacker tray 326 in the large-volume stacker 120. Therefore, in the case of the long sheet B, it is only possible to switch the discharge destination in the finisher 130.

For example, in the case of inspecting a sheet having a long length in the sub-scanning direction of the sheet size, such as a long sheet, the sheet size may be longer than the conveyance distance (length of the conveyance path) from the CIS sensors 315 and 316 to the flapper F1a. In this case, the leading end of the sheet reaches the flapper F1a before the inspection result of the sheet is known. As a result, the discharge destination of the sheet cannot be switched between the stacker 321 and a discharge destination downstream of the stacker 321 depending on the inspection result. Similarly, in the case of the long sheet B, the leading end of the sheet reaches the flapper F2a before the inspection result of the sheet is known. As a result, the discharge destination of the sheet cannot be switched between the stacker tray 326 and a discharge destination downstream of the stacker tray 326 depending on the inspection result.

In the second embodiment, assuming that the length of the conveyance distance from the scanning position by the CIS sensor to the flapper F2a is 800 mm, in the case of the long sheet B whose length of the sheet exceeds 800 mm, the leading end of the sheet reaches the flapper F2a before the sheet inspection is completed. In the case where the discharge destination of the sheet is the stacker 321 and the stacker tray 326 in "purge mode", it is determined that the inspection cannot be performed and an error occurs in the case where the inspection result is not output before the sheet reaches the flapper F2a. Therefore, in the case of "purge mode", for example, switching discharge of the long sheet B to the stacker 321 and the stacker tray 326 becomes × (N/A).

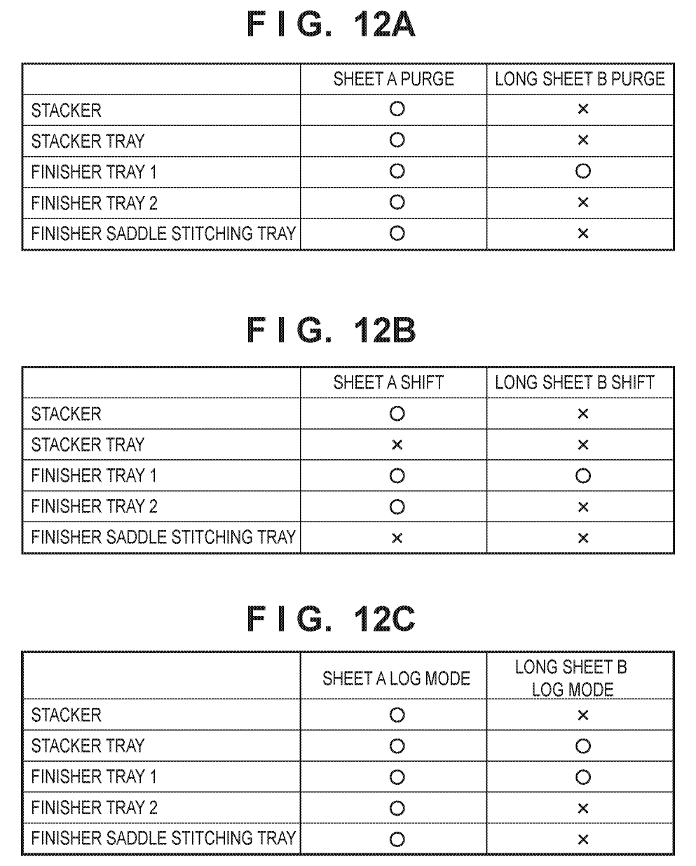

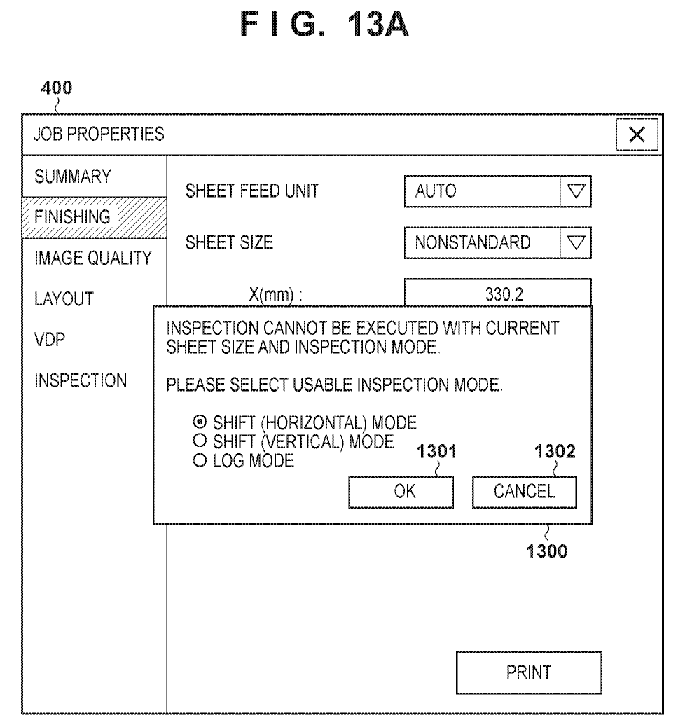

FIGS. 12A to 12C depict views illustrating examples of tables in which discharge destinations to which the printed matter can be discharged or cannot be discharged are registered in association with the sheet size and the inspection mode according to the second embodiment. Note that in FIGS. 12A to 12C, the length of each sheet has the following relationship: (distance from the CIS sensor to the flapper F1b) > the long sheet B> (the distance from the CIS sensor to the flapper F2a (800 mm)) > (the distance from the CIS sensor to the flapper F1a) > the sheet A.

FIG. 12A depicts a view illustrating a case of the purge mode or the purge & recovery mode, FIG. 12B depicts a view illustrating a case of the shift (horizontal) mode or the shift (vertical) mode, and FIG. 12C depicts a view illustrating a case of the log mode.

As illustrated in FIG. 12C, in the case of the log mode, in the long sheet B, the discharge destination compatible with discharge of the long sheet indicated in the long sheet compatibility 1001 of FIG. 11, that is, the stacker tray 326 and the discharge tray 331 meet the discharge-enabling condition. It can be seen that the sheet A can be discharged to all the discharge destinations.

As illustrated in FIG. 12B, in the case of the shift mode, in the sheet A, the discharge destinations compatible with shift sorting indicated in the shift 1002 of FIG. 11 meet the discharge-enabling condition. That is, since the stacker 321 of the large-volume stacker 120 and the discharge trays 331 and 332 of the finisher 130 are compatible with shift sorting, they meet the discharge-enabling condition of the sheet A. In the shift mode of the long sheet B, the discharge destination compatible with discharge of the long sheet indicated in the long sheet compatibility 1001 and the discharge destination compatible with shift sorting of the shift 1002 meet the discharge-enabling condition. That is, in the shift mode of the long sheet B, only the discharge tray 331 of the finisher 130 meets the discharge-enabling condition.

As illustrated in FIG. 12A, in the case of the purge mode, in the case of the sheet A, as indicated in the sheet A switching 1003 of FIG. 11, all the discharge destinations meet the discharge-enabling condition.

On the other hand, in the case of the purge mode of the long sheet B, the discharge destination compatible with discharge of the long sheet indicated in the long sheet compatibility 1001 and the discharge destination compatible with the long sheet B switching indicated in the long sheet B switching 1004 meet the discharge-enabling condition. Hence, in this case, only the discharge tray 331 of the finisher 130 meets the discharge-enabling condition.

In this manner, in step S1006, with reference to the above-described table, upon determining that the discharge destination selected in step S1005 meets the discharge-enabling condition, the processing proceeds to step S1007, and, when determining that the discharge destination does not meet the discharge-enabling condition, the processing proceeds to step S1008. In step S1007, the CPU 261 classifies the discharge destination determined to meet the discharge-enabling condition as a discharge destination selection candidate, and the processing proceeds to step S1009. In step S1008, the CPU 261 classifies the discharge destination that does not meet the discharge-enabling condition as a discharge destination unselectable candidate, and the processing proceeds to step S1009. In step S1009, the CPU 261 determines whether determination of all the discharge destinations has been completed. In the case where the determination of all the discharge destinations has not been completed, the processing returns to step S1005, and the CPU 261 selects the next discharge destination to perform the processing described above. When the determination of all the discharge destinations is completed in this manner, the processing proceeds to step S1010.

In step S1010, the CPU 261 determines whether there is a discharge destination that is a possible discharge candidate. Specifically, in the case of the log mode or the shift mode, the CPU 261 determines whether there are one or more discharge destinations that are possible discharge candidates. In the case of the purge mode, the CPU 261 determines whether there are two or more discharge destinations that are possible discharge candidates. For example, in the case where the purge mode is set for the long sheet B, the discharge destination to which the printed matter can be discharged is only the discharge tray 331 of the finisher 130 according to FIG. 12A, and the number of discharge destinations necessary for the purge mode is not satisfied. In this case, the CPU 261 determines that there is no discharge destination that is a possible discharge candidate. As described above, with the specific sheet and the inspection mode, there is no discharge destination to which the printed matter can be discharged, and the inspection cannot be performed. The processing proceeds to step S1011 when determining in step S1010 that there is a discharge destination that is a possible discharge candidate, but the processing proceeds to step S1012 in the case of determining that there is no discharge destination that is a possible discharge candidate.

In step S1012, the CPU 261 determines whether the user UI operation determined in step S1003 is the change of the sheet size. Here, the processing proceeds to step S1013 when determining that the sheet size is changed, and proceeds to step S1016 in the case of an operation other than the change of the sheet size. In step S1013, the CPU 261 displays a warning screen 1300 illustrated in FIG. 13A, for example.

FIG. 13A depicts a view illustrating an example of the warning screen 1300 to be displayed on the UI unit 263 of the information processing apparatus 160 according to the second embodiment.

The warning screen 1300 displays inspection modes in which there can be a possible discharge candidate in step S1010. In FIG. 13A, the shift (horizontal) mode, the shift (vertical) mode, and the log mode are displayed as inspection modes having possible discharge candidates. At this time, the user selects any of these displayed inspection modes and presses an OK button 1301. Alternatively, when not desiring any of these displayed inspection modes, the user presses a cancel button 1302.

In step S1014, the CPU 261 determines whether the change is permitted on the warning screen 1300. Specifically, in the case where the user selects the inspection mode to be changed on the warning screen 1300 and presses the OK button 1301, the CPU 261 determines that the change of the inspection mode is permitted on the warning screen 1300, and the processing proceeds to step S1015. On the other hand, in the case where the cancel button 1302 is pressed, the CPU 261 determines that the change of the inspection mode is not permitted, and the processing returns the inspection mode to the setting before the change notification in step S1002, and proceeds to step S1019. That is, the change of the inspection mode by the user via the UI unit 263 received in step S1002 is canceled. In step S1015, the CPU 261 changes the inspection mode to the inspection mode selected on the warning screen 1300 and the processing proceeds to step S1011.

By this, in a certain inspection mode, in the case where there is no possible discharge candidate when the sheet size is changed, it is possible to avoid a state in which inspection cannot be performed by changing the inspection mode.

Note that here, since the sheet size is changed in step S1012, in the case where there is no possible discharge candidate, the changed sheet mode is prioritized to change the inspection mode in step S1015. However, the warning screen 1300 may make it possible to select a sheet size for which a possible discharge candidate exists in the current inspection mode.

When the user UI operation determined in step S1003 is not the change of the sheet size, that is, the change of the inspection mode, the processing proceeds to step S1016, and the CPU 261 displays the warning screen 800 illustrated in FIG. 8A to proceed to step S1017. In step S1017, the CPU 261 determines whether the change of the sheet size is permitted on the warning screen 800. Specifically, in the case where the OK button 801 is pressed on the warning screen 800, the CPU 261 determines that the change of the sheet size is permitted, and the processing proceeds to step S1018. On the other hand, in the case where the cancel button 802 is pressed on the warning screen 800, the CPU 261 determines that the change of the sheet size is not permitted, and the processing returns the sheet size to the setting before the change notification in step S1002, and proceeds to step S1019. In step S1018, the CPU 261 changes the sheet size to a size less than a predetermined size and the processing proceeds to step S1011. For example, let the length of the sheet be L, and let the distance from the CIS sensors 315 and 316 to the flapper F2a be D, the inspection cannot be performed with a sheet size of D < L if the inspection mode is changed to a mode other than the log mode. Here, a sheet size satisfying D > L is set. Alternatively, a time T that can be used for inspection is T = (D - L)/S when the conveyance speed of the sheet is S. By this, a sheet size that can secure the inspection time T may be set. Alternatively, a sheet of a standard size, for example, the A4 size may be selected from among sheet sizes that can secure the inspection time T. In step S1011, the CPU 261 updates the discharge destination list so as to include a discharge destination to which the printed matter can be discharged in the current inspection mode and the processing proceeds to step S1019.

By this, with a certain sheet size, in the case where there is no possible discharge candidate when the inspection mode is changed, it is possible to avoid a state in which inspection cannot be performed by changing the sheet mode.

Note that here, since the inspection mode is changed in step S1012, in the case where there is no possible discharge candidate, the changed inspection mode is prioritized to change the sheet size in step S1018. However, the warning screen 800 may make it possible to select an inspection mode in which a possible discharge candidate exists with the current sheet size.

FIG. 13B depicts a view illustrating an example in which the discharge destination list is updated and displayed on the job property screen in the case where the inspection mode is changed to the shift (horizontal) mode with the long sheet B. As illustrated in FIG. 12B, the discharge destination to which the printed matter can be discharged in the shift mode with the long sheet B is only the discharge tray 331 (finisher tray 1) of the finisher 130. Therefore, in the discharge destination list, only the finisher tray 1, which can be selected, is normally displayed, and the other discharge destinations are displayed with strikethroughs added. In the second embodiment, an example is illustrated in which unselectable discharge destinations are displayed with shading off, but they may be grayed out or hidden, and any display may be used as long as it can be recognized that the discharge destination cannot be selected.

Then, in step S1019, the CPU 261 determines whether the setting of the inspection mode and the sheet size has ended. In the case of determining that the setting has not ended, the processing returns to step S1002, and the CPU 261 receives a notification of the user UI operation via the UI unit 263, but in the case where the setting ends, the CPU 261 ends this processing. Here, for example, when a save button (not illustrated) is pressed, the CPU 261 determines that the setting ends, and saves the setting of the job property screen into the storage unit 268 to end the processing. Alternatively, the CPU 261 may determine that the setting has ended upon pressing of the print button 408, save the setting of the job property screen into the storage unit 268 to end this processing, and execute the printing or inspection operation based on the input setting.

In the second embodiment, the method of executing the processing of step S1003 and subsequent steps upon receiving a notification of the UI operation in step S1002 has been described. However, the present disclosure is not limited to this, and may adopt a configuration in which, for example, at the time of obtaining the setting value in step S1001, determination on existence or absence of a possible discharge candidate is performed based on the sheet size and the inspection mode setting, and the warning screen display illustrated in step S1013 or step S1016 is performed to change the setting on the job property screen.

As described above, according to the second embodiment, it is possible to provide an inspection system that is able to avoid a state in which inspection cannot be performed by changing the inspection mode or the sheet size in the case where there is no discharge destination to which the printed matter can be discharged in the current inspection mode and the sheet size.

Note that in the above embodiments, inspection of the printed matter is performed by the inspection unit 110 and the inspection apparatus 170, but the present disclosure is not limited to such a configuration. For example, the inspection unit 110 may function as an inspection apparatus having an inspection function of the inspection apparatus 170, and may be able to execute processing from scanning of the printed matter to inspection. This inspection apparatus may be configured to be able to communicate with the information processing apparatus 160 and the client PC 150 via the network 180.

### Other Embodiments

Embodiments of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-013210, which was filed on January 29, 2025 and which is hereby incorporated by reference herein in its entirety.

What is claimed is:

1. An inspection system that compares a scanned image in which a printed matter printed based on a job is scanned with a reference image to inspect the printed matter, the inspection system comprising:
a plurality of discharge destinations; and
one or more controllers including one or more processors and one or more memories, wherein the one or more controllers are configured to:
set an inspection mode and a sheet size to be used for printing of the printed matter for the job,
determine whether the plurality of discharge destinations include a discharge destination to which the printed matter having been inspected in the inspection mode is able to be discharged, based on the sheet size and the inspection mode that have been set, and
perform control so as to change the inspection mode or the sheet size in a case that it is determined that there is no discharge destination to which the printed matter having been inspected is able to be discharged.

2. The inspection system according to claim 1, wherein in the determination, the one or more controllers determine that there is no discharge destination to which the printed matter having been inspected is able to be discharged, in a case where the inspection mode includes a first inspection mode in which a printed matter determined to be a defect by the inspection and a printed matter determined to be normal are discharged to discharge destinations different from each other, and the sheet size is a predetermined size or more, and
wherein in the control, the one or more controllers perform control so as to change the first inspection mode to a second inspection mode, which is different from the first inspection mode, in a case that it is determined that there is no discharge destination to which the printed matter having been inspected is able to be discharged.

3. The inspection system according to claim 2, wherein the predetermined size is a size at which at least two discharge destinations among the plurality of discharge destinations are not able to be selected as a discharge destination to which the printed matter is able to be discharged, at a time point when an inspection result of the printed matter is determined.

4. The inspection system according to claim 2, wherein the second inspection mode is an inspection mode in which the printed matter determined to be a defect by the inspection and the printed matter determined to be normal are discharged to a same discharge destination.

5. The inspection system according to claim 2, wherein in the determination, in a case where the one or more controllers determine that the discharge destination to which the printed matter having been inspected is able to be discharged exists because a discharge destination that is able to be selected in a case where the sheet size is the predetermined size or more is compatible with shift sorting where the printed matter determined to be a defect by the inspection and the printed matter determined to be normal are discharged to be shifted relative to each other in a conveyance direction of the printed matter or the direction orthogonal to the conveyance direction,
in the control, the one or more controllers sets the second inspection mode as an inspection mode in which the printed matter determined to be a defect by the inspection and the printed matter determined to be normal are discharged by performing the shift sorting.

6. The inspection system according to claim 2, wherein in the control, the one or more controllers further display a screen prompting a user to change the sheet size, and change the sheet size when the user instructs the change of the sheet size via the screen.

7. The inspection system according to claim 2, wherein in the control, the one or more controllers further display a screen prompting a user to change the first inspection mode to another inspection mode, and change the inspection mode in response to an operation by the user via the screen.

8. The inspection system according to claim 7, wherein the screen includes a candidate of an inspection mode that is able to be changed as the other inspection mode.

9. The inspection system according to claim 1, wherein in the determination, the one or more controllers
obtain a conveyance distance of the printed matter from scanning of the printed matter to outputting of an inspection result based on the sheet size, and
obtain a discharge destination that is able to be selected as a discharge destination among the plurality of discharge destinations based on the conveyance distance, and determine, based on the obtained discharge destination, whether there is a discharge destination to which the printed matter having been inspected in the inspection mode is able to be discharged.

10. The inspection system according to claim 1, wherein in the setting of the sheet size and the inspection mode, the one or more controllers is further able to set a failed sheet discharge destination to which a printed matter determined to be a defect by the inspection is discharged in a case where the inspection mode includes a first inspection mode in which a printed matter determined to be a defect by the inspection and a printed matter determined to be normal are discharged to discharge destinations different from each other.

11. An information processing apparatus included in an inspection system that inspects a printed matter printed based on a job and includes a plurality of discharge destinations to which the inspected printed matter is able to be discharged, the information processing apparatus comprising:
one or more controllers including one or more processors and one or more memories, wherein the one or more controllers are configured to:
set an inspection mode and a sheet size to be used for printing of the printed matter for the job,
determine whether the plurality of discharge destinations include a discharge destination to which the printed matter having been inspected in the inspection mode is able to be discharged, based on the sheet size and the inspection mode that have been set, and
perform control so as to change the inspection mode or the sheet size if determining that there is no discharge destination to which the printed matter having been inspected is able to be discharged.

12. The information processing apparatus according to claim 11, wherein in the determination, the one or more controllers determine that there is no discharge destination to which the printed matter having been inspected is able to be discharged, in a case where the inspection mode includes a first inspection mode in which a printed matter determined to be a defect by the inspection and a printed matter determined to be normal are discharged to discharge destinations different from each other, and the sheet size is a predetermined size or more, and
wherein in the control, the one or more controllers perform control so as to change the first inspection mode to a second inspection mode, which is different from the first inspection mode, in a case that it is determined that there is no discharge destination to which the printed matter having been inspected is able to be discharged.

13. The information processing apparatus according to claim 12, wherein the predetermined size is a size at which at least two discharge destinations among the plurality of discharge destinations are not able to be selected as a discharge destination to which the printed matter is able to be discharged, at a time point when an inspection result of the printed matter is determined.

14. The information processing apparatus according to claim 12, wherein the second inspection mode is a mode in which the printed matter determined to be a defect by the inspection and the printed matter determined to be normal are discharged to a same discharge destination.

15. The information processing apparatus according to claim 12, wherein in the determination, in a case where, the one or more controllers determine that the discharge destination to which the printed matter having been inspected is able to be discharged exists because a discharge destination that is able to be selected in a case where the sheet size is the predetermined size or more is compatible with shift sorting where the printed matter determined to be a defect by the inspection and the printed matter determined to be normal are discharged to be shifted relative to each other in a conveyance direction of the printed matter or the direction orthogonal to the conveyance direction,
in the control, the one or more controllers set the second inspection mode as an inspection mode in which the printed matter determined to be a defect by the inspection and the printed matter determined to be normal are discharged by performing the shift sorting.

16. The information processing apparatus according to claim 12, wherein in the control, the one or more controllers further display a screen prompting a user to change the sheet size, and change the sheet size when the user instructs the change of the sheet size via the screen.

17. The information processing apparatus according to claim 12, wherein in the control, the one or more controllers further display a screen prompting a user to change the first inspection mode to another inspection mode, and change the inspection mode in response to an operation by the user via the screen.

18. The information processing apparatus according to claim 17, wherein the screen includes a candidate of an inspection mode that is able to be changed as the other inspection mode.

19. The information processing apparatus according to claim 11, wherein in the determination, the one or more controllers
obtain a conveyance distance of the printed matter from scanning of the printed matter to outputting of an inspection result based on the sheet size, and
obtain a discharge destination that is able to be selected as a discharge destination among the plurality of discharge destinations based on the conveyance distance, and determine, based on the obtained discharge destination, whether there is a discharge destination to which the printed matter having been inspected in the inspection mode is able to be discharged.

20. The information processing apparatus according to claim 11, wherein in the setting of the sheet size and the inspection mode, the one or more controllers is further able to set a failed sheet discharge destination to which a printed matter determined to be a defect by the inspection is discharged in a case where the inspection mode includes a first inspection mode in which a printed matter determined to be a defect by the inspection and a printed matter determined to be normal are discharged to discharge destinations different from each other.

21. An inspection system that compares a scanned image in which a printed matter printed based on a job is scanned with a reference image to inspect the printed matter, the inspection system comprising,
a plurality of discharge destinations; and
one or more controllers including one or more processors and one or more memories, wherein the one or more controllers are configured to:
set a sheet size and an inspection mode to be used for printing of the printed matter for the job; and
perform control so as to change the inspection mode or the sheet size based on that there is no discharge destination to which the printed matter having been inspected is able to be discharged, in a case where the set sheet size is a predetermined size or more and the set inspection mode is an inspection mode in which a destination of a printed matter determined to be a defect by the inspection is discharged and a destination of a printed matter determined to be normal is discharged are different from each other.
